(19) United States
(12) Patent Application Publication
(10) Pub. No.: US 2022/0366502 A1
(43) Pub. Date: Nov. 17, 2022

(54) System and Process For Developing Positive Behavioral Wellness Using A Virtual Trustee

(71) Applicant: Troutwood, LLC, Pittsburgh, PA (US)

(72) Inventors: Eugene M. Natali, Jr., Pittsburgh, PA (US); Jeffrey Richard Davidek, Pittsburgh, PA (US); Dorian Brown, Pittsburgh, PA (US)

(73) Assignee: Troutwood, LLC, Pittsburgh, PA (US)

(21) Appl. No.: 17/746,499

(22) Filed: May 17, 2022

Related U.S. Application Data
(60) Provisional application No. 63/189,446, filed on May 17, 2021.

(51) Int. Cl. G06Q 40/06; G06Q 30/02; G06F 3/0482

(52) U.S. Cl. CPC G06Q 40/06; G06Q 30/0203; G06F 3/0482

(57) ABSTRACT

An investment management system is provided and includes a single general user interface; and a computer connected to the single general user interface and having: a computer readable storage device having a database module for collecting, storing, and linking data associated with a user financial profile and performance of a user account; and a central processing unit connected to the single general user interface and the computer readable storage device, and running a plurality of core modules running: a manner for inputting user provided information selected from the group consisting of personality traits, financial experience, financial goals, and combinations thereof; and means for presenting a simulated list of user compatible virtual trustee advisors; and means for input for a user to select a user determined board of virtual trustees from the provided list of virtual trustee advisors and that correspond with a determined user profile from user information.

### CROSS-REFERENCE TO RELATED APPLICATION

This application claims the benefit of U.S. Provisional Patent Application No. 63/189,446, filed on May 17, 2021.

### FIELD OF INVENTION

This disclosure relates to financial investment education and, more particularly, to an investment management system for developing positive behavioral financial wellness using a virtual financial trustee to help a user with goal achievement.

### BACKGROUND

Approximately 115 million Americans do not invest. Basic education teaching investment “know how” to general population is greatly lacking, and traditional pension fund availability is sharply declining, a trend likely to persist. Whereas retirement has historically been “employer directed” it is quickly becoming “employee directed”. There is no greater need within financial education than preparing individuals for this changing retirement and investment landscape. Financial challenges to the general population are numerous, including a student loan crisis, which continues to grow. Corporations and even municipal and state governments are freezing or eliminating their pension plans. The minimum age for Social Security eligibility has risen and may continue to rise. This cumulative reduction of the United States retirement safety net is an issue of national importance. The demand and need to help Americans, particularly young Americans, develop viable plans to achieve financial stability is very high. What is needed is a system that will help users develop viable plans, provide modelling of financial outputs in response to entered variables, and optionally provides for a financial simulation activity that may be utilized as part of an education curriculum, or for investor education programs. Such a system may beneficially provide users with a better understanding of the impact of financial decisions and life choices and provide positive reinforcement and communication to help users implement, maintain, and successfully realize those financial plans and goals.

Further, many young adults fail to appreciate the need for long-term investing, withdraw after losses, or are intimidated of the process. As a result, many young professionals fail to invest at all, or fail to continue investing early in their professional careers. In some instances, long term investors will emotionally react to adverse, near term events in the overall marketplace and sell without concern about the impact on long term goals. The early years of an investment life cycle, paired with less investment know-how at this stage, results in individuals being most prone to making mistakes and pulling investments or failing to continue investing, especially when viewed in the light of their remaining human capital and theoretical ability to continue contributing to their investment portfolio for many years to come. The institutional investment model applied by many pension funds, is an example of the validity to individuals also staying the course and maintaining a long-term focus.

Therefore, there is a need reinforce and drive behavioral change of investors through tools and programs directed to promote financial wellbeing.

### SUMMARY

Accordingly, a system and process for developing behavioral wellness is provided through an investment management system having a financial trustee module to reinforce good behavioral wellness and increase the odds of an investor to achieve set financial goals.

### BRIEF DESCRIPTION OF THE DRAWING(S)

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1-10 are exemplary images of the graphical user interface and examples of the service modules necessary for performing the tasks of the investment management system, according to the invention having at least an investment management module and a virtual trustee module;

FIG. 11 is a is schematic diagram of hardware infrastructure for an investment management system according to an exemplary embodiment of the invention;

FIG. 12 is a schematic diagram of hardware infrastructure for front end and back end framework of an investment management system according to an exemplary embodiment of the invention;

FIG. 13 is a schematic diagram of exemplary connection between a front end and a back end framework of an investment management system according to an exemplary embodiment of the invention;

FIG. 14 is a schematic diagram of exemplary protocol between a front end and a back end framework of an investment management system according to an exemplary embodiment of the invention;

FIG. 15 is a flow chart of exemplary steps performed by a user authentication module for an investment management system according to an exemplary embodiment of the invention; and

FIG. 16 is a schematic diagram of an investment management system according to the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

Other systems, methods, features and advantages of the invention will be or will become apparent to one with skill in the art upon examination of the following figures and detailed description.

In an embodiment, the teachings herein describe a system and process that allows a user to invest toward a selected retirement goal with assistance of one or more designated virtual coaches or trustees (hereinafter “trustee”) from a library of diverse trustees having distinct characters that are matched to a user's personality. The virtual trustee is intended to help increase the odds of the user achievement of goals set in a selected financial plan (i.e., retirement).

Individuals will have the option of selecting one or more trustees, for example, a small group of approximately 3-5 trustees, or any suitable number of trustees, from a library of diverse trustees provided and accessed within the system. Alternatively, or additionally, the user may take a user assessment, which may be in the form of a user behavioral quiz, and based on the user's assessment results, the in system may assign one or more trustees from the library, where the trustees assigned, or selected by the user, may be tailored to that user's characteristics, as determined through the user assessment. Each trustee may be clearly defined in terms of role, profile, and types of continued interactions and/or push notifications to be sent. For example, on a simple level, the trustees for the user are intended to help the user achieve the goal set in a financial plan. In an embodiment of the invention, the virtual trustees may be a complete behavioral overlay on top of a financial planning app, using both artificial intelligence (AI) and machine learning to customize the interaction between the trustee and the user. In the broadest sense, the user selected trustee may overlay the financial planning app, and serve the role that known financial advisers, coaches or trustees would play in helping the user achieve their goals. In an embodiment of the invention, the user may have the option of periodic meetings, for example, annual, quarterly or monthly meetings, with the selected virtual trustees, in a virtual board meeting. In periods of stress (e.g., downturns in the market), these virtual board meetings may occur more regularly, for example, occurring on a shorter periodic timeframe, such as weekly, and even daily, if necessary; the meetings may even be provoked by virtual trustee automatically (i.e., triggered by event or user decision). For instance, these virtual board meetings may replicate the meeting that is held are each quarter by pension fund trustees. Each virtual trustee of a board of virtual trustees may provide behavioral specific updates. The virtual trustee board may also invite expert “guests” into the board meeting. This may be a referral to a human specialist or another virtual trustee that specializes in change of user personality or behavior. For instance, this may be an asset class specific virtual trustees, such as an equity, real estate, fixed income, or crypto trustee. Another example includes debt specialists, such as home loan, student loan, auto loan and credit card.

Typically, the role of trustees is to help to ensure the plan's managers, staff, and consultants stay within the guidelines outlined by regulations or policy statements (i.e., Pension Funds Investment Policy Statement). In an embodiment of the system, the virtual trustee may perform a similar objective, with an emphasis on remaining consistent with the unique behavioral biases that each individual user may have. Thus, the goal of the virtual trustee is generally twofold: (1) replicate the role that known human trustees play in helping achieve investor performance goals of the user, and (2) replicate the role that financial wellness coaches play in helping users and manage their behavioral biases. The virtual trustee may advise the user, to make sure the user stays within the “boundaries of a plan”, which may be part of an investment strategy defined by, or suggested to the user, within the system.

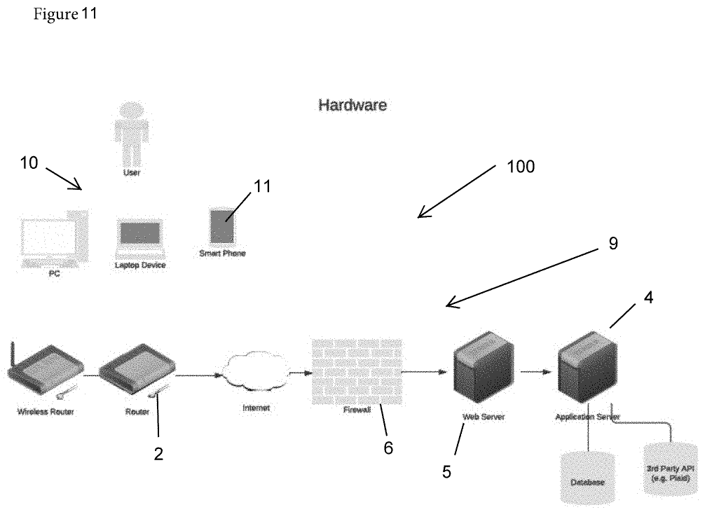

In an exemplary embodiment of the invention, a user may use an investment management system, as may be provided or accessed through an app (e.g. on a user's computer or mobile device) or utilize a web based tool that permits a user to manage money and investments and may be guided by one or more virtual trustees, selected or assigned from a library of diverse trustees, each having distinct characters that may be selected to be matched to a user's personality. The investment management system may employ software and hardware. Various aspects of the hardware, modules, and methods of use of an exemplary embodiment of the investment management system 100 are further described, with reference to FIGS. 11-16.

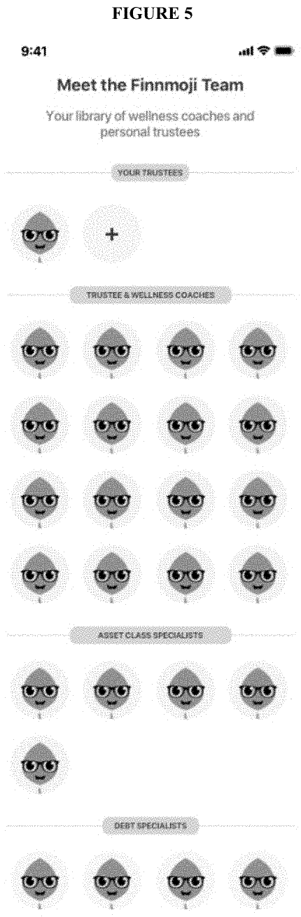

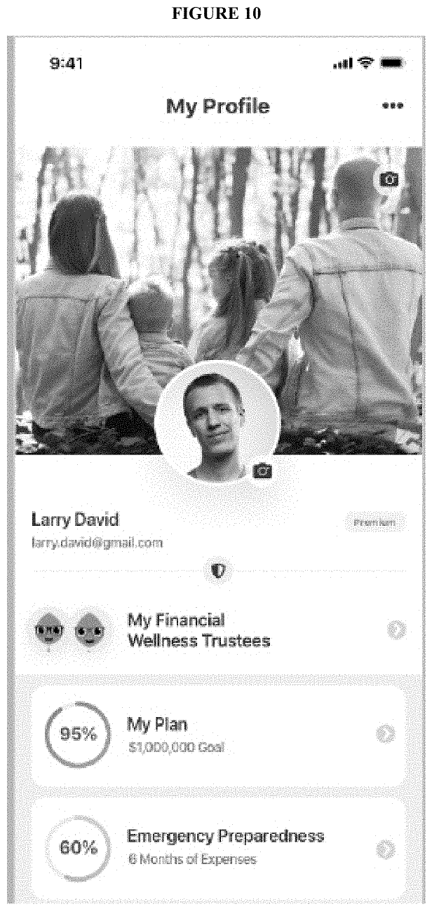

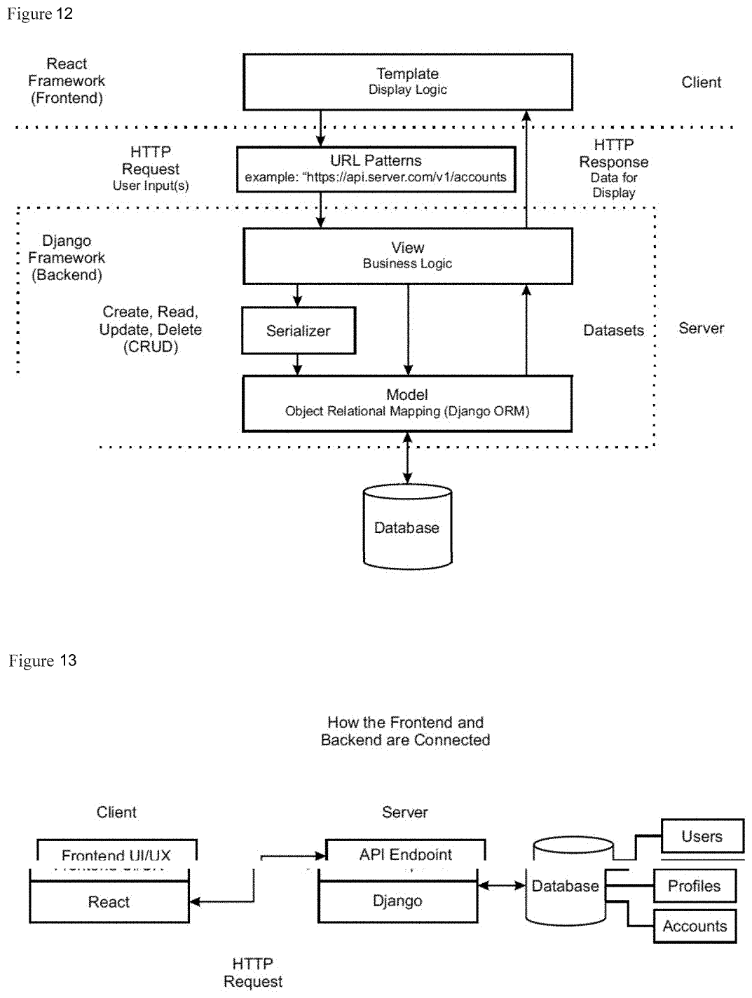

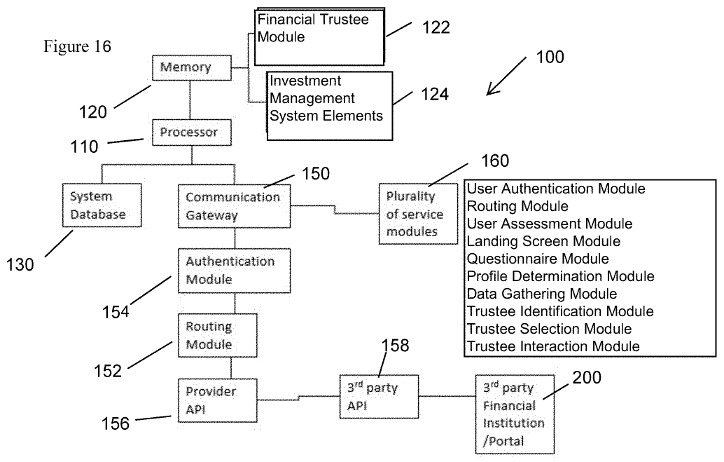

Hardware infrastructure for an embodiment of the investment management system will be described, with reference to FIG. 11. To perform the aforementioned and other functions, the investment management system generally includes a plurality of integrated system servers with one or more databases (i.e., internal information repository), a network interface 8 accessible through various known communication protocols, such as TCP/IP, cellular protocols including GSM, Wi-Fi, Wi-Max, or other wireless communications technologies or combination of wired or wireless channels, network security devices (where necessary), and a computing device having a processing unit and memory. In an embodiment, the investment management system 100 may provide the exemplary hardware infrastructure having an exemplary system architecture as depicted with reference to FIG. 11, and may be built on one or more network routers 2 (for instance, a wireless router) and connected to a database application server 4 having access to one or more databases files, while also utilizing known hardware components, including a web server 5, a firewall 6, a network 9, and the computing device 10 of the user. It is contemplated that, in an embodiment where the user's computing device is a terminal such as a PC or laptop, for example, the computing device 10 may be directly connected by network communication cable to the router 2, and the wireless router depicted may not be necessary. More commonly, the user end of the network 9 is provided with a computing device 10 that is a laptop, PC, tablet, or smart phone that can communicate wirelessly, and access the internet through a wireless communication system, such as a wireless router or using cellular signal, as will be familiar to those of ordinary skill in the art, that the computing device may connect to the internet, or be directed through a network router 2 in order to access the internet, as shown in FIG. 5. In an embodiment, the computing device 10 may be a tablet computer or smart phone with a touchscreen display 11. The touchscreen display 11 may use finger or stylus gestures to navigate the general user interface (GUI) provided on the screen by the software. However, one skilled in the art should appreciate that other implements could be used; including a computer mouse, a keyboard, or joystick. In fact, one skilled in the art should appreciate that the computing device may be a physical computer and could be, but not limited to, a desktop computer, a laptop computer, or a cell phone, and utilize a downloaded app or web browser. The computing device 10 is to be provided with memory device that is a storage device having computer components and recording media used to retain digital data. The processor of the computing device is a central processing unit (CPU) that manipulates data stored in the memory device by performing computations. The interaction and communications between the graphical user interface and the display visible to the user (the front end) and the interactions with the database, or financial account information (the back end) are depicted in the simplified schematic of FIGS. 12 and 13. In an alternative embodiment, the investment management system files, including market return data and formulas, and programming language necessary for performing the simulation may be loaded into the memory device of the computing device, and performable by the processor, utilizing user inputs through the interface, as will be described. In such an embodiment, there may be no need for communication through the network interface to communicate with external devices (e.g., servers) through a network router. With reference to the schematic depiction of the investment management system 100 shown in FIGS. 10 and 16, the computing device 10, as discussed above, and as known to those of skill in the art, generally includes a general user interface that can be detected on the display 11 of a computing device 10, utilizing a memory device 120, and a processor 110.

The investment management system 100 allows a user to access a plurality of user options and system files that include data, such as information and images, through the computing device 10 and a network traffic information on the database application server 4 (i.e., SQLServer or or PostgreSQL (also known as Postgres) or newer) that connects to a web server 5. The web server 5 functions as a way for the network router 2 to communicate to the database application server 4 using an application-programming interface (API) for communications between the computing device 10 and the database server 4. In an embodiment, the application database server 4 may house a data aggregator API that can connect to one of a database file for a financial institution, or governmental agency, such as the Bureau of Labor Statistics (BLS) or alternatively to a third party API that facilitates electronic access to the financial information of the user's financial account, using techniques known to those skilled in the art. A firewall 6 may be integrated for security purposes such as, but not limited to, blocking unauthorized access to the web server 5 and the resulting unauthorized communication thereto. The investment management system 100 is designed to run through the computing device 10 utilizing the saving simulation files for the application or program that are preferably loaded onto the user's computing device 10, such as into the memory of the computing device, and supplemented with information communicated through the network as will be discussed. It is contemplated that, alternatively, the investment management system files may be downloaded through the network 9 from an application server 4. The investment management system 100 is designed to run through the computing device 10, and through a plurality of modules utilized in the investment management system that may be downloaded and function over any suitable network system 9, including personal area networks (PANs), local area networks (LANs), campus area networks (CANs), wide area networks (WANs), metropolitan area networks (MANs) and any new networking system developed in the future. One skilled in the art should appreciate that the investment management system 100 can be maintained solely through the computing device 10, as the investment feedback files can be pre-loaded to the computing device. In such an instance, the user may input details regarding the current financial account balance, thereby avoid the need to have the computing device 10 access a third party databases or API to update the account information via network 9. Additional information from outside sources may be updated less frequently than the user financial account information, for example, the data may only be updated once per quarter (e.g., 4 times per year) or less, and thus may be updated through an application update on the user's computing device 10, rather than rely on frequent updates. In the shown embodiment, the user may connect to the network router 2 using the computing device 10 and update information through the network 9, for instance. FIG. 12 illustrates an exemplary embodiment of the front end and back end framework of the investment management system 100. FIGS. 13 and 14 also provide exemplary architecture and protocol for the investment management system 100. Though one skilled in the art would appreciate that other hardware and protocol designs are possible as long as such modifications would not divert from the spirit of the invention.

In an alternative embodiment, the investment management system files, including market return data and formulas, and programming language necessary for performing the simulation may be loaded into the memory device of the computing device, and performable by the processor, utilizing user inputs through the interface, as will be described. In such an embodiment, there may be no need for communication through the network interface to communicate with external devices (e.g., servers) through a network router.

An exemplary embodiment of the process flow and interactions between component devices for the operation of the investment management system will be described with reference to the simplified schematic diagram of FIG. 16. The investment management system 100 includes a processor 110, utilizing memory 120, as may be associated with the computing device described previously, an application database 130, which may also be referred to as the system database. The investment management system 100 further includes a communication gateway 150 and a plurality of service modules 160 executable by the processor 110 accessing or running the Investment Management Module and Financial Trustee Module. The service modules 160 may include at least one or more supporting modules, including for example: an “Authentication” module, a “Routing” module; a “Landing Screen” module; a “Questionnaire” module or a “User Assessment” module, a “Profile Determination” module; a “Data Gathering” module; a “Trustee Identification” module; a “Trustee Selection” module; a “Trustee interaction” or “Check-in” module; and a “My Plan Summary” module, as will be discussed.

Now with reference to the Figures, the investment management system 100 will be described. The investment management system includes an investment management module for running investment management and a virtual financial trustee module for carrying out various aspects of the invention, as described above.

### Investment Management Module

The investment management module is a set of operations and commands that permit a user to plan and manage investments and capital expenditures through a general user interface. The investment management module contains functions for generating a plan and managing investments in view of the selected plan. The user can monitor their spending, investments and budget in view of that selected plan and life events that may affect that plan. The financial trustee module will overlay on top of the investment management module, using both artificial intelligence (AI) and machine learning to customize the interaction between the trustee and the user.

### Financial Trustee Module

The financial trustee module is also a set of operations and commands that relies on actions carried out by a plurality of service modules: (1) a questionnaire module for user input as part of a user assessment, (2) a profile determination module based on the user input, (3) a data gathering module for collecting information about the user, (4) a trustee identification module, (5) a trustee selection module, and (6) trustee interaction module.

The questionnaire module will provide one or more questionnaire, games, and or interaction meetings with the user for user input. The user provides input that is then analyzed, and the profile determination module will determine personality traits, experience and tendencies based on that user input. To further evaluate the user, the data gathering module will collect other relevant information about the user, including personal and public information that may conflict with or support user input. Once all the user data is collected, the trustee identification module will identify one or more (i.e., 3-5) virtual trustees from the library of virtual trustees that correspond/match with a determined user profile. This could be based on various personality traits and experience but could be based on user wanting to change “known” habits and traits. Once the user is presented with matching virtual trustees, the trustee selection module assigns a selected virtual trustee to the user and trustee interaction module allows the virtual trustee to interact with the user over time to help the user achieve their goals selected in the investment management module.

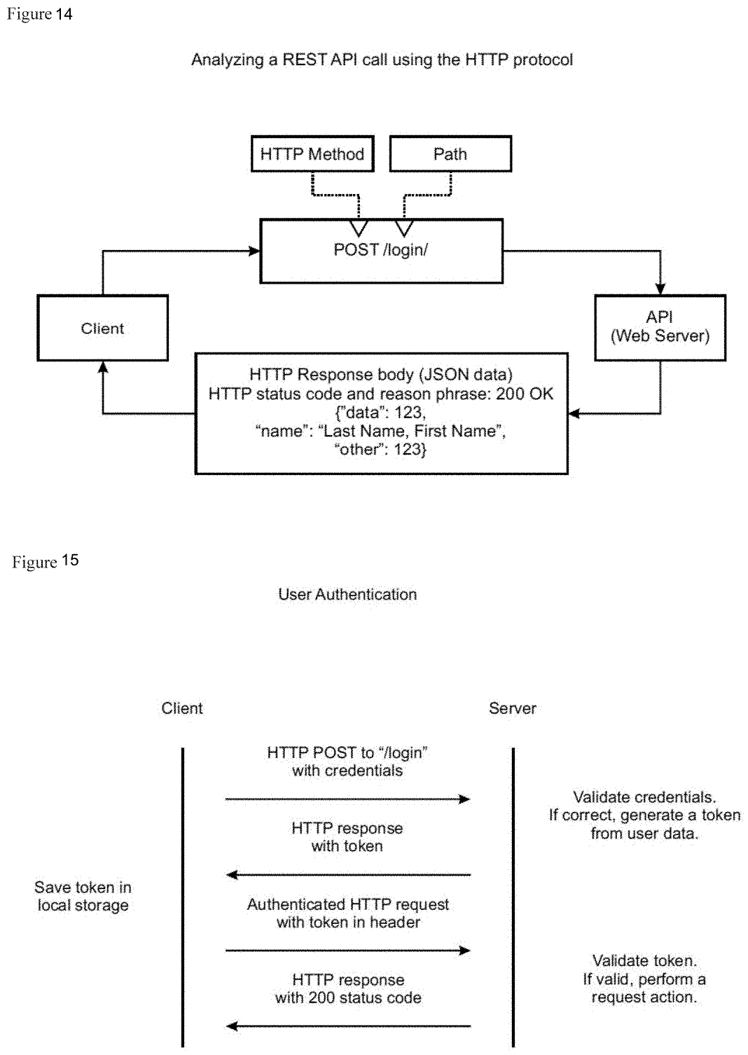

For exemplary purposes, the authentication module is depicted in FIGS. 16 and performance detailed in FIG. 15.

The processor 110 shown in FIG. 11 may be any type of computer processor known to those with ordinary skill in the art and capable of executing the processes described herein. The memory 120 connected to the processor 110 is any non-transitory computer readable medium known to those with ordinary skill in the art including, for example, persistent memory such as magnetic and/or optical disks, ROM, and PROM and volatile memory such as RAM. The memory 120 stores a plurality of algorithms executable by the processor 110. The various algorithms, when executed by the processor 110, implement an authentication module 152 and a routing module 154 of the communication gateway 150 and may also implement the services modules 160 as described in greater detail below. The memory 120 may also store a library of virtual trustee elements 122, along with the investment management system module elements 124, such as investment management system files, including market return data and formulas, and programming language.

The communication gateway 150, in addition to the authentication module 152 and the routing module 154, includes a provider Application Programming Interface (“API”) 156 and a third party API 158 as shown in FIG. 11. The provider API 156 and the third party API 158 are each a set of software instructions stored on the system memory 120; each API 156, 158 is a set of subroutine definitions, protocols, and tools that, when executed by the processor 110, permits communication between disparate software components. Each API 156, 158 is configured to convert electronic data between different formats, such that the same electronic data is readable by each of the disparate software components. In an exemplary embodiment, the provider API 156 and the third party API 158 are both configured to convert electronic data between a JavaScript Object Notation (“JSON”) format and an Extensible Markup Language (“XML”) format. As would be understood by those with ordinary skill in the art, conversion between other known formats is also possible. In an embodiment of the invention, each API 156, 158 is a Representational State Transfer (“RESTful”) API, with a schematic of the interactions depicted in FIG. 14.

The investment management system 100 may be connected to and communicate with one or more third party financial institutions, financial portals, or job and data sources, such as government agencies 200 through the communication gateway 150 (e.g., over the internet) to integrate data related to the user's financial accounts or other statistical information necessary for the simulation, across the investment management system 100. Portions of the investment management system 100 may be cloud-based via the internet and may be located remotely from the user processor 110 and third party financial institutions 200.

The investment management system 100 may employ an investment management module utilizing, in an exemplary embodiment, the hardware depicted in FIG. 5. The investment management system 100 further relies on actions carried out by a plurality of service modules 160 helpful for carrying out various aspects of the invention, as will be described.

### The Authentication Module

The authentication module allows for the secure log-in of the user, such as by using a password and username for the account that may be selected by the user during initial setup, and stored in memory for authenticating follow on events. It is also contemplated that alternatively, or additionally, one or more of personal identification number (PIN), challenge response, security token, hardware token, signature recognition, facial recognition, fingerprint scan, biometric data, and two-factor authentication credentials may similarly be employed to authenticate the user, as will be understood by those of skill in the art. The authentication module ensures that the user's identity is authorized or authenticated. Once the user's identification has been authenticated, the investment feedback system may be more fully utilized, such as by performing additional service modules, as will be discussed. Further, the user credentials for an authenticated user may be conveyed securely through the communication gateway, as may be required for interactions with a third party API 158, and/or for access to a third party portal, such as a for a financial institution hosting the user's account.

An example of protocol for the authentication module 152 is shown in FIG. 15, showing the interactions between client and server to verify and authenticate the user by providing login credential information, and token exchange.

### The Landing Screen Module

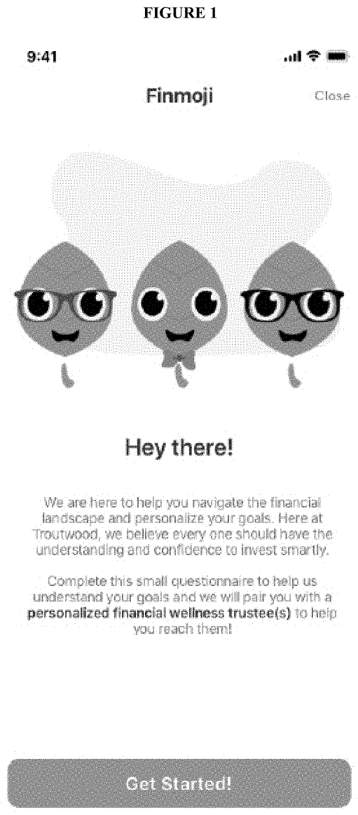

FIG. 1 depicts an embodiment of the user interface display for the landing screen module, where the user is welcomed to the system, and may be provided instructions for the navigating within the system, and further provides a user selectable starting icon, which allows the user to continue through a plurality of additional service modules described below. Example greeting and instructions for the landing screen module may read: “Hey there! We are here to help you navigate the financial landscape and personalize your goals. Here at Troutwood, we believe everyone should have the understanding and confidence to invest smartly. Complete this small questionnaire to help us understand your goals and we will pair you with a personalized financial wellness trustee(s) to help you reach them!” Additionally, the option to select the home button, should the user wish to return to the initial landing screen module, may be available at many points throughout the operation of the investment management system.

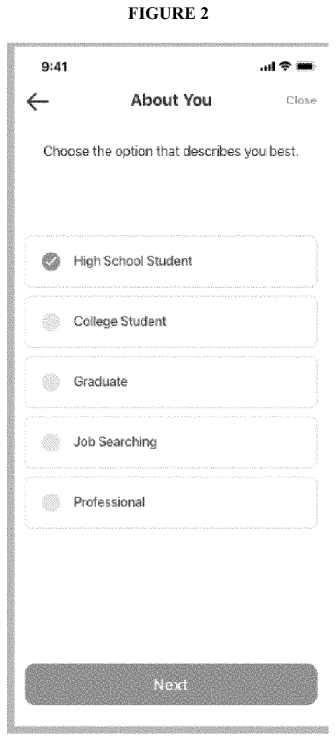

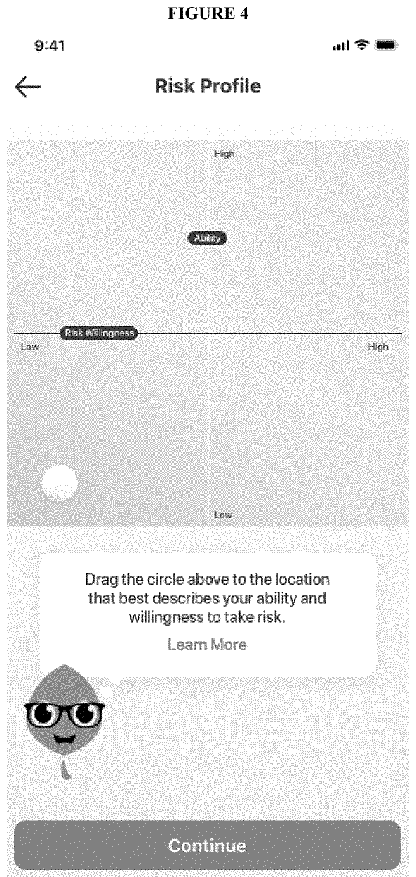

Selection of the starting icon, for example, the user selectable button labelled “get started” may initiate the user assessment module, which gather's user background information and information useful for determining the user's financial goals and provide additional information relevant for developing a user-specific investment strategy, for example, as depicted in FIGS. 2-4.

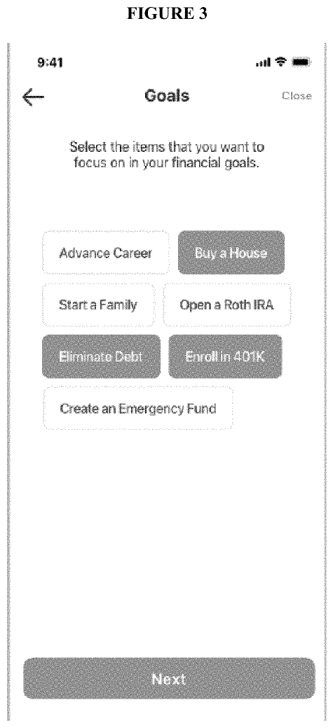

The Questionnaire module may request background information specific to the user, as depicted in FIG. 2, such as the user's professional or educational status. Additionally, the questionnaire module may request the user to enter information necessary for performing a user assessment that is based on a relevant profile of the user. In an embodiment, the user is able to enter information about the user's current age, location, and number of years the user wishes to save or invest. The number of years will typically correspond to the number of years until the user would expect to retire, though it may be any suitable number of years selected by the user. Additionally, the questionnaire module may request financial goal information specific to the user, as depicted in FIG. 3, for example where the user may select one or more financial goals, such as: advance career, buy a house, eliminate debt, enroll in 401k, create an emergency fund, which the user may select to indicate that goal is of interest to the user in determining financial goals for the current user. Additionally, with reference to FIG. 5, the Questionnaire module may request user specific information to develop a risk profile, for example, by requesting the user to identify that user's willingness to accept risk in pursuing financial goals, as well as assessing the user's ability to take on risk in pursuing financial goals or following a proposed investment strategy. In an embodiment, the user may indicate that user's risk profile information, by adjusting within the user display, the placement of a marker within an image having a first axis (e.g. along an X axis) representing a gradient of risk tolerance having opposing ends that are indicative of low risk tolerance and high risk tolerance, and a second axis oriented orthogonal to the first axis (e.g., along a Y axis) representing a gradient for ability to withstand risk, again with ends that are high and low ability to withstand risk. It is contemplated that the questionnaire module may also gather any nature of relevant information from the user that would be helpful in determining an accurate user profile, such information may fall outside of the example information provided, yet fall within the teachings herein. The profile determination module of the system will then assess the user's provided information (e.g., age, goals, years till retirement, and/or risk information) entered in the questionnaire module for determining the profile of the user. For example, the profile determination module will assess the user's placement location of the marker along the gradients of the X and Y axis, and then utilizing the positional information, may assign a categorical value to the user's risk profile, which categorical value may be utilized for developing the user's investment strategy and develop a user specific group of virtual trustees. As depicted in FIGS. 2 through 4, the user may navigate between information question panels within the Questionnaire module by selection of the advance icon, such as the “next” icon, or alternatively, a “continue” icon, as depicted.

A data gathering module of the investment management system may gather additional data relevant to establishing a user profile. For example, once authenticated in the manner discussed herein, the data gathering module may access the user's account information, which may be periodically updated. The data gathering module may rely on outside data, such as through the use of an API web server.

The trustee identification module is depicted in FIG. 5 providing a character representation of a library of trustees available within the system and may identify, or present to the user a list of suggested individual trustee characters from the library of trustees that may be selected to complete the group of trustees particular to the user's profile and investment strategy. The Trustee selection module, in an embodiment, may be either by automatic selection within the system, where the system evaluates the information gathered through the User Assessment module, and using programmed logic, and/or artificial intelligence, may present a list of trustees automatically to the user, which may be subject to user confirmation; or alternatively, the trustee selection module may provide a list of suggested virtual trustees, but it is the user that selects the group of virtual trustees within the system.

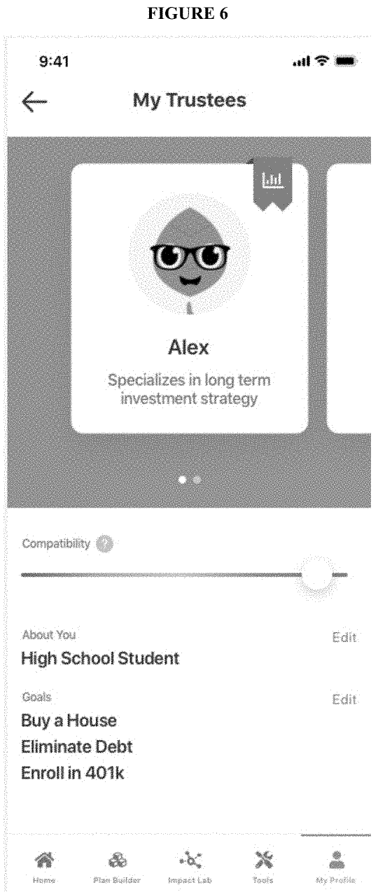

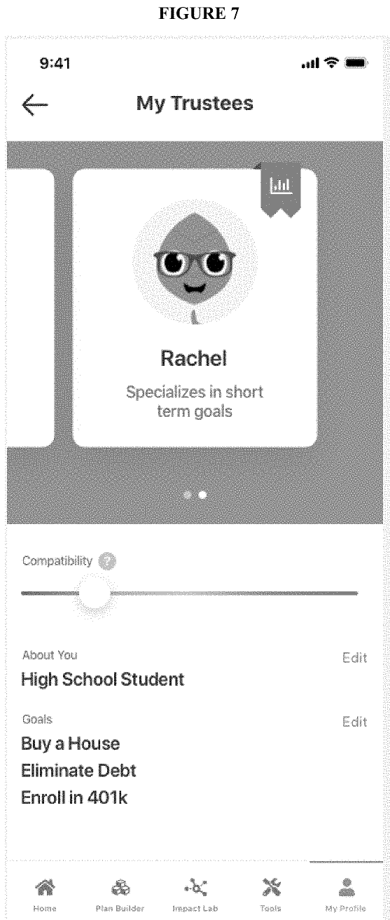

As depicted in FIGS. 6 and 7, the details of each particular virtual trustee, including trustee characteristics, such as a measurement of user compatibility, and/or a summary of the virtual trustee's specialization, may be reviewable by the user, either as part of the trustee selection process within the trustee selection module, or upon reviewing the trustees assigned within the system, for example as part of the trustee interaction module. The measurement of the user compatibility for each virtual trustee character may be an indicator of compatibility, such as by providing a numerical value (e.g., 1-100), where higher number value is associated with higher compatibility, or alternatively, other scales of compatibility may be provided, such as providing a grade value (e.g., A, B, C, D, F) or category value (e.g., excellent, good, fair, poor, bad), indicative of that virtual trustee's compatibility with the user.

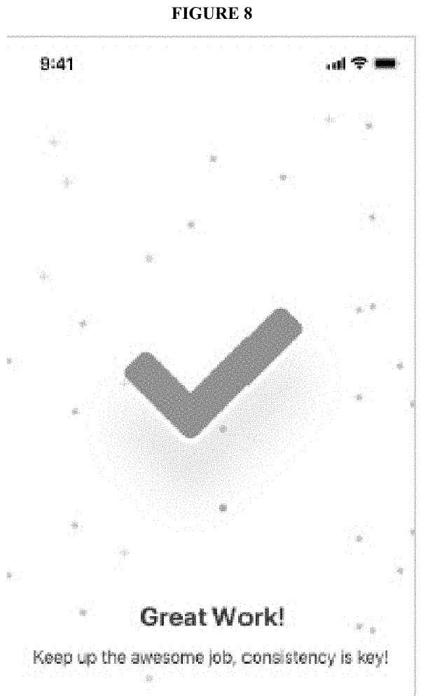

Upon completion of the roster of the user specific board of virtual trustees within the trustee selection module, a congratulatory screen may be provided for the user display, such as is depicted in FIG. 8, encouraging the user to follow up with the investment strategy information provided within the system.

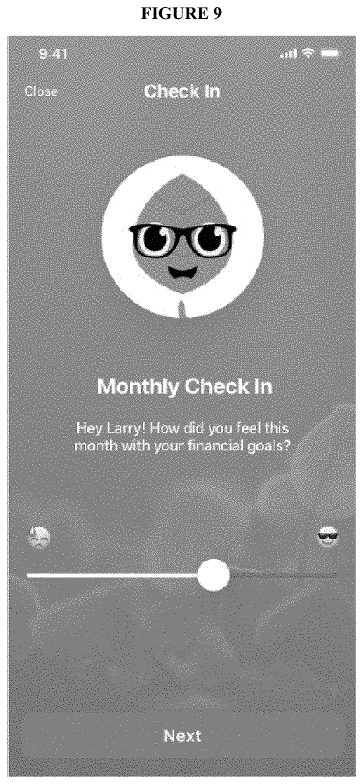

With reference to FIG. 9, the system may encourage periodic check-ins, through a trustee interaction module, where the user can navigate within the system, and assess user performance towards financial goals and conformance with the user specific investment strategy. FIG. 9 depicts the user display for the check-in or trustee interaction module and may prompt the user to self-assess conformance with the strategy for the most recently completed period; for example, as depicted, the user may complete a self-assessment entry by entering a value in a text entry, or as shown, adjusting a marker on a sliding scale between poor compliance (represented by the frowning face emoji) and good compliance (represented by the smiley face emoji). Additionally, the system may access the user's financial information, for example by authenticating the user's identity, and conveying the user credentials through the communication gateway to access savings or investment account information, through third party API calls to outside sources, for access to a third party portal, such as for a financial institution hosting the user's account, in order for the system to evaluate conformance with the investment strategy or performance within the system. The system will evaluate the user entered periodic self-assessment value, and may provide feedback to the user, or may adjust the user's investment strategy, as exemplary outcomes from the periodic check-in.

FIG. 10 depicts the user profile within the “My Plan Summary” module of the system and may optionally include a link to the list of virtual trustees utilized within the system, and further may provide current status on compliance with the user specific investment strategy plan, for example, as a measurement towards the user specific financial goals. In an embodiment, the feedback within the user profile may indicate current status of the financial goal, e.g., the user has achieved 95% of the user specific goal of value in an investment account; or where the user has entered a goal of achieving 6 months of expenses as an emergency preparedness goal, the feedback may indicate the user's progress towards that goal, such as indicating the user is 60% towards the goal of having funds equivalent to 6 months of average expenses, as the user specific emergency preparedness goal.

In the foregoing specification, the invention has been described with reference to specific embodiments thereof. It will be evident, however, that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions, including the ability for the user to personalize. Additionally, and obviously, features may be added or subtracted as desired. Accordingly, the invention is not to be restricted except in light of the attached claims and their equivalents. What is claimed is:

1 An investment management system, comprising:
a single general user interface; and
a computer connected to the single general user interface and having:
a computer readable storage device having a database module for collecting, storing, and linking data associated with a user financial profile and performance of a user account; and
a central processing unit connected to the single general user interface and the computer readable storage device, and running a plurality of core modules running:
a means for input for a user to provide user information selected from the group consisting of personality traits, financial experience, financial goals, and combinations thereof;
means for presenting a simulated list of user compatible virtual trustee advisors; and
a means for input for a user to select a user determined board of virtual trustees from the provided list of virtual trustee advisors and that correspond with a determined user profile from user information.

2. The investment management system of claim 1, wherein the plurality of core modules further generates a recommended financial investment strategy to provide an amount for the user to invest for each year to meet the user's financial goal.

3. The investment management system of claim 2, wherein the plurality of core modules includes a landing screen module to provide the instructions.

4. The investment management system of claim 3, wherein the plurality of core modules further includes a questionnaire module permitting the user to enter user information about a user's risk tolerance and ability to withstand risk, along with the user's current age, and a number of years the user wishes to follow a financial plan to meet the user's financial goal.

5. The investment management system of claim 4, wherein the plurality of core modules further includes a my plan summary module that provides current feedback to the user on following a recommended investment strategy.
